(19) United States
(12) Patent Application Publication
(10) Pub. No.: US 2019/0044468 A1
(43) Pub. Date: Feb. 7, 2019

(54) Method for Operating at Least One Electric Motor and/or Stationary Work Machine Coupled Therewith, and Stationary Work Machine

(71) Applicant: Kriwan Industrie-Elektronik GmbH, Forchtenberg (DE)

(72) Inventor: Christian Ellwein, Schwäbisch Hall (DE)

(21) Appl. No.: 16/009,790

(22) Filed: Jun. 15, 2018

(30) Foreign Application Priority Data
Aug. 3, 2017 (DE) 10 2017 117 604.7

(51) Int. Cl. H02P 29/028; H02P 27/04; H02P 29/64; H04L 29/06

(52) U.S. Cl. CPC H02P 29/028; H02P 27/04; H04L 63/0209; H04L 63/1441; H04L 63/1416; H02P 29/64

(57) ABSTRACT

A method for operating at least one electric motor and/or stationary work machine coupled therewith, wherein the electric motor is controlled during normal operation by means of at least one first controller and at least one frequency converter, with the at least one first controller and/or the frequency converter being connected at least temporarily to the internet. Furthermore, during emergency operation, the electric motor can be controlled by means of at least one second controller that cannot be connected to the internet, whereas the controlling of the electric motor via the first controller and the frequency converter is interrupted.

### TECHNICAL FIELD

The invention relates to a method for operating at least one electric motor and/or a stationary work machine coupled therewith, and to a stationary work machine.

### BACKGROUND

Stationary work machines such as pumps, compressors, compressors, fans, or hoists are very often driven by an electric motor that is controlled by a frequency converter and a controller. The frequency converter is used particularly to save energy during partial-load operation of the work machine or to improve the control quality of the process.

The controller reads in the measured values of one or more sensors. These can be, for example, the back pressure in a refrigerant compressor, the filling level in a pumping station, or the end position in a hoist. The sensors are used to describe the process to be controlled and to generate the control signals for the frequency converter and the motor in the controller. The frequency converter can be connected to the power grid via a motor protection device or disconnected from the power grid by the motor protection device by means of a safety chain.

It is becoming more and more commonplace for the controller and/or the frequency converter to be connected to the internet. This can be achieved via different interfaces, such as LAN, WLAN, Bluetooth, or USB, with Bluetooth and USB in particular only enabling a temporary connection to the internet, while LAN and WLAN usually a establish a permanent connection. This connection to the internet makes the system easier to configure, maintain, and adapt to changing environmental conditions. It is also possible to change the control algorithm via the internet—in the form of an update, for example. The system can also send data to higher-level systems in order to support optimization at a higher system level. Besides the advantages of remote maintenance, preventive maintenance, etc., this networking also entails new cybersecurity risks. Particularly in working machines in critical infrastructure areas, such as a cold chain for food, the water supply, the disposal of wastewater, fans for fire protection (smoke extraction), or the ventilation of stables in animal husbandry, reliable operation is of central importance. If operation is disrupted by a cyberattack, it can easily affect the care, health, or even life of humans.

A cyber-physical system is known from DE 10 2015 119 597 A1 with which the protection against a cyberattack (such as a hacker attack or other unwanted manipulation via the internet) can be improved. To this end, it is proposed that a wired interface to the internet and a transmitter and/or receiver unit for transmitting and/or receiving data via the internet be provided. The wired interface communicates with a controllable switch for physically separating and releasing the connection between the cyber-physical system and the internet. The cyber-physical system has at least one control device for controlling the controllable switch for the momentary release of the connection between the cyber-physical system and the internet. Through the controllable switch, the cyber-physical system can be disconnected from the internet in a complete and absolutely secure manner during normal operation. Only when an event occurs is the controllable switch switched by the control unit so as to release the connection to the internet. The release is therefore only for the purpose of transmitting and/or receiving data and is therefore very short-term, particularly shorter than 1 minute, preferably shorter than 30 seconds. The cyber-physical system is therefore visible on the internet only for the brief moment of release, thus rendering hacker attacks or unwanted manipulations extremely difficult.

Another possibility for improving the safety of systems is known from DE 10 2015 113 885 A1. The system described therein provides at least one system component for monitoring and/or setting the system that has a bi-directional interface for a field-based, bidirectional communication path with a user and a unidirectional communication path for transmitting data from the at least one system component to a gateway. Via the unidirectional communication path, all desired data concerning the state of the system can thus be transmitted to the system and stored via the gateway on a server that can be accessed via the internet and retrieved there by authorized persons. Access to the system component via the gateway is denied due to the unidirectional design of the communication path, so that no data can be transmitted from the gateway to the at least one system component. Of course, it is necessary for the system component to still be able to be parameterized or set by a user. According to the invention, this is achieved via the bidirectional interface of the system component with a bidirectional communication path to be established on site with the user. Parameterization or setting of the system component is thus possible only via the bidirectional communication path to be established on site.

The measures proposed in DE 10 2015 119 597 A1 and DE 10 2015 113 885 A1 present possibilities for making unwanted access to the installation over the internet more difficult. Today, however, an at least temporary linking of system components to the internet is now explicitly desired.

Processes and methods are therefore needed by means of which a cyberattack can be identified and appropriate countermeasures initiated. DE 10 2014 109 279 A1 discloses a method for protecting an electric motor and/or a work machine coupled therewith against spurious operation in which the number of spurious operations of the electric motor and/or work machine is determined according to a first error criterion and the number of spurious operations of the electric motor and/or working machine is detected and summed up according to a second error criterion. An alarm signal is generated and/or the electric motor is switched to a predefined state when the sum of the detected spurious operations exceeds a specified limit. In this method, it is assumed that the electric motor and/or the working machine are already being controlled by a malicious code. By summing up spurious operations based on at least two different error criteria, a critical state can be detected even if the electric motor and/or work machine is still within the desired range with respect to a specific error criterion.

### SUMMARY

It is the object of the invention to further improve the security and the operation of at least one electric motor and/or stationary work machine coupled therewith.

According to the invention, this object is achieved by the features of claims 1 and 11.

In the method according to the invention for operating at least one electric motor and/or stationary work machine coupled therewith, the electric motor is controlled during normal operation by means of at least one first controller and at least one frequency converter, with the at least one first controller and/or the frequency converter being connected at least temporarily to the internet. Furthermore, during emergency operation, the electric motor can be controlled by means of at least one second controller that cannot be connected to the internet, whereas the controlling of the electric motor via the first controller and the frequency converter is interrupted.

According to the invention, the stationary work machine provides at least one electric motor, with at least one first controller and at least one frequency converter being provided for controlling the electric motor during normal operation, and with the at least one first controller and/or the frequency converter being at least temporarily in communication with the internet. Furthermore, a motor protection device is provided with a second controller that is not connected to the internet for controlling the electric motor during emergency operation, with the motor protection device being connected to at least a first relay for the purpose of interrupting control of the electric motor via the first controller and/or the frequency converter during emergency operation.

By virtue of the solution according to the invention, the electric motor can be disconnected from the first controller and/or the frequency converter in the event of a cyberattack, with emergency operation being ensured by the second controller. As a result, the basic functionality of the work machine, such as supplying drinking water or continuing to refrigerate a cold store, for example, continues to be carried out. Since the operation takes place without the frequency converter, a higher level of power consumption on the part of the electric motor and/or deteriorated control quality is accepted only for a transition period until the cyberattack is repelled.

This security concept applies particularly to work machines such as pumps, compressors, fans, hoists, etc., that form an important part of our infrastructure.

According to a preferred embodiment of the invention, the electric motor is operated in emergency mode as soon as a cyberattack on the electric motor and/or stationary work machine coupled therewith is detected. One way to detect a cyberattack is to provide a firewall between the first controller and/or the frequency converter and the internet. Once the firewall detects a corresponding cyberattack, a motor protection device can be actuated appropriately so as to interrupt the control of the electric motor via the first controller and/or the frequency converter and to provide for emergency operation via the second controller. Because the second controller is not connected to the internet at any time, it can be reliably ensured that the electric motor is not controlled by an unwanted manipulation. In addition, basic functionality is maintained, even if this is achieved by means of non-power-optimized operation if necessary.

Another way to detect a cyberattack is through self-monitoring of the first controller and/or the frequency converter. This can be achieved, for example, by employing a method according to DE 10 2014 109 279 A1, in which the number of spurious operations of the electric motor and/or associated work machine according to a first error criterion and the number of spurious operations of the electric motor and/or and associated work machine according to a second error criterion are detected and summed up, with a cyberattack being detected by the fact that the sum of the detected spurious operations exceeds a specified limit. With regard to further embodiments of this method, express reference is made to DE 10 2014 109 279 A1.

Another method for detecting a cyberattack is known from the earlier application DE 10 2016 114 805 A1. That application describes a method for monitoring, controlling, or regulating a machine with the aid of an embedded system that has a first processor that is acted upon by an input signal that is processed by means of a first algorithm implemented in a first processor in order to generate a first output signal for controlling or regulating the machine, with it being possible for the first algorithm of the first processor to be altered via a network interface. The embedded system also employs a second processor that is not connected to the network interface and is supplied with the same input signal, which is processed by means of a second algorithm, which is implemented in the second processor in order to produce a second output signal, with the first output signal of the first processor and the second output signal of the second processor being compared in order to determine whether the first algorithm has been changed in relation to the second algorithm.

An embedded system is understood to mean a system with at least one processor that is integrated in a technical context. The processor particularly undertakes monitoring, control, or regulating functions and, in doing so, can also process data or signals in particular.

This method addresses the needs of the industry for a straightforward and quick customization of the system via a network interface. Even if appropriate security measures are taken, it cannot be completely ruled out that persons will gain unauthorized access and carry out manipulations. By providing the second processor, however, there is a processor that is independent of the network interface, which normally operates on the same algorithm as the first processor. However, if the first algorithm in the first processor is manipulated in an unauthorized manner, the comparator detects that the output signals of the two processors are different, thus enabling a cyberattack to be detected. If this method for detecting a cyberattack is applied to the present invention, the first controller and/or the inverter are equipped with two processors, only one of which is connected to the internet. If the comparator to be implemented also determines that the output signals of the two processors are different, then a cyberattack is in progress, so that the motor protection device switches from normal operation to emergency operation (control via the second controller).

With regard to further embodiments of the method with two processors, express reference is made to DE 10 2016 114 805 A1.

During normal operation, the electric motor or the frequency converter is controlled as a function of at least one sensor signal that describes the process to be controlled. For example, these can be the back pressure in a refrigerant compressor, the fill level at a pumping station, or the end position in a hoist. In a first evaluation device that is integrated into the first controller, the sensor signals are evaluated for adherence to target values in order to control the electric motor via the frequency converter as a function of the sensor signals. Usually, the electric motor is controlled such that the detected parameter is in a predetermined target range and held there. However, if the at least one detected parameter exceeds specified limit values, a provision can be made that the electric motor is completely switched off or, if appropriate, operated at reduced power at first.

In particular, the stationary work machine can be a compressor for refrigerant or air, a pump, a hoist, or a fan.

### BRIEF DESCRIPTION OF THE DRAWING

Additional embodiments of the invention will be explained in greater detail in the description and drawing that follow.

FIG. 1 of the drawing shows a circuit diagram for controlling an electric motor 1 in normal operation and in emergency operation.

### DETAILED DESCRIPTION

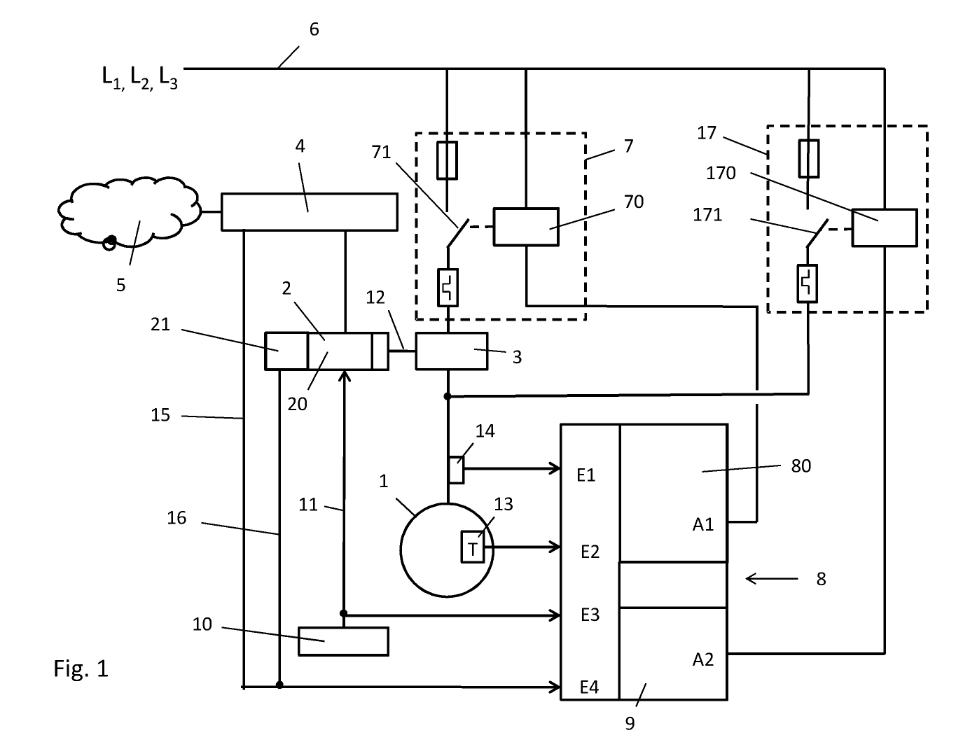

The electric motor 1 shown in FIG. 1 is part of a stationary work machine, for example, which is a compressor for refrigerant or air, a pump, a hoist, or a ventilator, for example. During normal operation, the electric motor 1 is controlled via a first controller 2 and a frequency converter 3, with the first controller 2 being connected to the internet 5 at least temporarily via a firewall 4. Power is supplied to the electric motor 1 via a three-phase power line 6, the first relay 7, and the frequency converter 3.

The first controller 2 is also connected to at least one, preferably a plurality of sensors 10 that detect at least one parameter of the electric motor and/or of the work machine connected thereto. For example, these can be the back pressure in a refrigerant compressor, the fill level at a pumping station, or the end position in a hoist. In a first evaluation device 20, which is integrated into the first controller 2, the resulting sensor signals 11 are evaluated for adherence to target values in order to control the electric motor via the frequency converter 3 as a function of the sensor signals 11.

The first evaluation device 20 of the first controller 2 is supplied with the sensor signals 11 and processes them by means of an algorithm that is implemented in a processor in order to generate an output signal 12 for controlling and regulating the frequency converter 3 and/or the electric motor 1. The sensors 10 are thus used to describe the process to be controlled and to enable the control signals for the frequency converter 3 and the electric motor 1 to be generated in the controller 2.

Among other things, the motor protection device 8 is used to monitor the electric motor 1 for critical states. For example, the temperature of a winding of the electric motor 1 can be read in and evaluated via an input E2 with the aid of a temperature sensor 13 for this purpose. The temperature sensor 13 is a PTC or a PT100, for example. Moreover, the sensor signals 11 of the sensor or sensors 10 and/or other sensors can be read in via the input E3. This can be the temperature of a hot gas or an oil level, for example. Furthermore, the three phases of the power line 6 can be read in via the input E1 over a current and/or voltage sensor 14 and monitored for critical conditions such as undervoltage, overvoltage, phase failure, or phase asymmetry.

The evaluation of the sensor signals is performed by an evaluation device 80 that is provided in the motor protection device. If a critical state for the electric motor 1 and/or the coupled, stationary work machine is detected, the electric motor 1 is switched off through deactivation of the first relay 7 via the output A1. In this case, the first relay 7 consists, for example, of a first coil 70 and a first working contact or normally-open contact 71.

In addition to this conventional motor protection function, the motor protection device 8 is also capable of initiating emergency operation of the electric motor 1 in the event of a cyberattack. A cyberattack can be detected in various ways. One possibility is for the firewall 4 to detect a cyberattack and send a corresponding first message 15 to the motor protection device 8. This first message 15 is read in via the input E4.

Moreover, the first controller 2 can be equipped with a self-monitoring device 21 that detects a cyberattack. This can be achieved using a method as described in DE 10 2014 109 279 A1 or by means of a design as described in DE 10 2016 114 805 A1. As soon as a cyberattack is detected in the first controller 2, a second message 16 is sent to the motor protection device 8.

In addition to these external options for detecting a cyberattack, however, detection that is implemented in the motor protection device 8 can also be provided. A cyberattack can be detected, for example, through evaluation of the current and voltage values read in via the input E1 by means of the current and/or voltage sensor 14 and/or additional sensor signals read in via the input E3. A method according to DE 10 2014 109 279 A1 can be used for this, for example.

If the motor protection device 8 detects a cyberattack based on the first message 15 from the firewall 4, the second message 16 from the self-monitoring device 21 of the first controller 2, or an internal evaluation of sensor signals, the motor protection device 8 disconnects the frequency converter 3 from the power grid via the first relay 7 and switches the electric motor 1 to the power grid (emergency operation) via a second relay 17 (with second coil 170 and second normally-open contact 171).

The second controller 9 is not connected to the internet at any time and therefore cannot be manipulated via the internet. The second controller is embodied by a PI controller, a PID controller, a two-position controller with hysteresis, or the like. The sensor signals of the sensors 10 continue to be read in via the input E3 and processed by the control algorithm of the second controller 9. However, the second controller 9 can now only switch the electric motor 1 on and off via the second relay 17 in order to perform the function of the electric motor. Partial load operation of the electric motor 1, which was previously carried out via the frequency converter 3, is then no longer possible in this so-called “emergency operation.” Nevertheless, the basic function of the electric motor 1 can be maintained, although losses in energy consumption and control quality must be accepted.

As soon as the cyberattack is averted, the electric motor 1 can be operated again through deactivation of the second relay 17 and activation of the first relay 7 via the first controller 2 and the frequency converter 3.

1. A method for operating at least one electric motor and/or a stationary work machine that is coupled therewith, wherein
the electric motor is controlled during normal operation via at least one first controller and at least one frequency converter, said at least one first controller and/or said frequency converter is connected to the internet at least temporarily, and
the electric motor is controlled during emergency operation via at least one second controller that cannot be connected to the internet, whereas the controlling of the electric motor via the first controller and the frequency converter is interrupted.

2. The method as set forth in claim 1, characterized in that the electric motor is operated in emergency mode as soon as a cyberattack on the electric motor and/or the stationary work machine coupled therewith is detected.

3. The method as set forth in claim 2, characterized in that a cyberattack is detected via a firewall.

4. The method as set forth in claim 2, characterized in that a cyberattack is detected through self-monitoring in the first controller or frequency converter.

5. The method as set forth in claim 2, characterized in that at least one parameter of the electric motor and/or of the stationary work machine coupled therewith is detected by at least one sensor and evaluated for the purpose of controlling the electric motor and/or of detecting a cyberattack.

6. The method as set forth in claim 5, characterized in that the sensor is formed by a current and/or voltage sensor that performs a current and/or voltage measurement in the vicinity of a power supply to the electric motor, and the current and/or voltage values detected by the current and/or voltage sensor are checked for specified error criteria in order to detect a cyberattack.

7. The method as set forth in claim 5, characterized in that the at least one sensor is formed by a temperature sensor that is arranged in a winding of the electric motor and detects, evaluates, and uses the temperature in the vicinity of the winding to control the electric motor.

8. The method as set forth in claim 1, characterized in that a motor protection device is provided that, in the event that a cyberattack is detected, interrupts the controlling of the electric motor via the first controller and the frequency converter by means of a first relay.

9. The method as set forth in claim 8, characterized in that, in the event that a cyberattack is detected, the motor protection device controls the electric motor via the second controller as a function of the parameters detected by the at least one sensor.

10. The method as set forth in claim 5, characterized in that, in the event that a cyberattack is detected, the motor protection device controls the electric motor via the second controller as a function of the parameters detected by the at least one sensor.

11. The method as set forth in claim 5, characterized in that the electric motor is switched off or operated at reduced power if the evaluation of the at least one measured parameter results in non-adherence to specified limits.

12. A stationary work machine with at least one electric motor, wherein at least one first controller and at least one frequency converter are provided in order to control the electric motor during normal operation, and the at least one first controller and/or the frequency converter are connected at least temporarily to the internet and, furthermore, a motor protection device with a second controller that is not connected to the internet is provided in order to control the electric motor during emergency operation, and wherein the motor protection device is connected to at least one first relay in order to interrupt the controlling of the electric motor via the first controller and/or the frequency converter during emergency operation.

13. A stationary work machine as set forth in claim 12, wherein means are provided for detecting a cyberattack.

14. The stationary work machine as set forth in claim 13, wherein the means for detecting a cyberattack is constituted by a firewall.

15. The stationary work machine as set forth in claim 13, wherein the means for detecting a cyberattack is constituted by a self-monitoring device that is implemented in the first controller and/or in the frequency converter.

16. The stationary work machine as set forth in claim 13, wherein the means for detecting a cyberattack comprises at least one sensor for detecting at least one parameter of the electric motor and/or of the associated work machine.

17. The stationary work machine as set forth in claim 12, wherein at least one sensor is provided in order to detect at least one parameter of the electric motor and/or of the work machine connected thereto, which sensor is connected to at least one evaluation device for the purpose of checking the detected parameters for adherence to target values.

18. The stationary work machine as set forth in claim 17, wherein the at least one sensor is embodied by a temperature sensor that is arranged in a winding of the electric motor and/or by a current and/or voltage sensor that is arranged in the vicinity of an power supply to the electric motor.

19. The stationary work machine as set forth in claim 12, wherein the motor protection device is connected to at least one second relay for the purpose of starting and stopping the electric motor.

20. The stationary work machine as set forth in claim 12, characterized in that the stationary work machine is a compressor for refrigerant or air, a pump, a hoist, or a fan.
